(19) United States
(12) Patent Application Publication
(10) Pub. No.: US 2025/0110382 A1
(43) Pub. Date: Apr. 3, 2025

(54) MANAGING COUPLING OF OPTICAL PROCESSING STAGES IN A SYSTEM

(71) Applicant: Ayo Electronics Inc., Boston, MA (US)

(72) Inventors: Peter Nicholas Russo, Arlington, MA (US); Michael Gould, Newport, VT (US)

(73) Assignee: Ayo Electronics Inc., Boston, MA (US)

(21) Appl. No.: 18/904,300

(22) Filed: Oct. 2, 2024

Related U.S. Application Data
(60) Provisional application No. 63/629,260, filed on Oct. 3, 2023.

(51) Int. Cl. G02F 1/365; G02F 1/355

(52) U.S. Cl. CPC G02F 1/365; G02F 1/3556; G02F 2202/06; G02F 2202/101; G02F 2202/102; G02F 2202/108

(57) ABSTRACT

In one aspect, an apparatus comprises: an integrated circuit device comprising a first layer comprising a metal, a second layer comprising a first semiconductor material, a third layer comprising an active region of a second semiconductor material, and a fourth layer comprising a third semiconductor material, wherein the second layer is between the first and third layers, and the third layer is between the second and fourth layers; an optical interface configured to provide optical waves into different respective portions of the active region along propagation axes that are substantially parallel to each other including first and second propagation axes; a plurality of metal contacts in electrical communication with the fourth layer, wherein first and second subsets of the metal contacts are arranged along the first and second propagation axes; and an electrical source configured to apply a respective electric field between the first layer and each metal contact.

### CROSS-REFERENCE TO RELATED APPLICATION(S)

This application claims priority to and the benefit of U.S. Provisional Application Ser. No. 63/629,260, entitled “Active Diffractive Optical Neural Networks,” filed Oct. 3, 2023, the entire disclosure of which is incorporated herein by reference.

### TECHNICAL FIELD

This disclosure relates to managing optical processing stages in a system.

### BACKGROUND

The field of artificial intelligence (AI) and neural network computing has witnessed exponential growth in recent years. The field is poised to revolutionize various industries, including machine learning, data analysis, and autonomous systems. Processors tailored to artificial intelligence applications are gaining popularity as they can reduce the time, cost, and power consumption associated with training and operating the massive Artificial Neural Networks (ANN) that make up the back-end of popular AI services.

To date, a popular processor for AI applications is the Graphics Processing Unit (GPU), which has been adapted from its original application, computer rendering of 3D images, to neural network processing. In some examples, GPUs have been useful for AI due to their widespread commercial availability and the similarity in processing requirements between ANNs and image rendering, as both applications can perform massively parallel floating-point calculations.

As engineers build ever-larger ANNs, the demand for processing power is growing at a rate faster than transistors are able to keep up. To date, a solution to this problem can be to spread the computation across many chips, using large racks of servers to perform the calculations. In some examples, combining chips together in such a manner can be limited by practical aspects such as space, cost, and power.

To reduce the power, size, and cost of AI processing, some ANN processors can utilize fundamentally different architectures, such as photonics platforms or optical architectures that can process and/or manipulate optical waves or light. Light can operate at a frequency that is about 10⁵ times higher than the typical clock frequency of a computer, which can allow light to carry signals with much higher bandwidth than electrical signals. Some photonic AI processors can use structures such as Mach-Zehnder Interferometers (MZIs) or ring resonators to modulate and interfere light as a surrogate for the multiply-accumulate operations associated with ANNs. In some examples, the output of the floating-point operation can be encoded in the electric field of the light such that the floating-point operation can be completed at sub-picosecond rates.

In some examples, a speed advantage associated with photonic processors can be hampered by the size of the photonic elements. The size of some photonic structures can be limited by the wavelength of the light which passes through them. For instance, a 200 μm×20 μm photonic structure could equivalently fit roughly 1.2 million transistors fabricated using a 3 nm process. Modern GPUs can achieve approximately 400 FLOPS/transistor, so the photonic element must perform much more than 480 million FLOPS to provide a chip area advantage. In some implementations, optimizing design of photonic ANNs can comprise increasing the speed of photonic elements and increasing the processing parallelism of a photonic ANN through means such as wavelength division multiplexing. In some examples, increasing these factors can be associated with increased power consumption and complexity.

Some photonic processing devices can comprise semiconductor materials such as silicon or III/V compounds. Some examples of III/V compounds comprise elements from group III of the periodic table, such as boron, aluminum, gallium, or indium. Some examples of III/V compounds comprise elements from group V of the periodic table, such as nitrogen, phosphorous, arsenic, or antimony. In some implementations, semiconductor materials can be doped with p-type or n-type dopants. In some implementations p-type dopants can comprise elements such as tin, germanium, silicon, tellurium, and sulfur. In some implementations n-type dopants can comprise elements such as zinc, cadmium, beryllium, and magnesium.

Some photonic processing devices can comprise optical waveguiding structures or optical circuits configured to guide optical waves in the optical wavelength region of the electromagnetic spectrum. Some electromagnetic waves have a spectrum that has a peak wavelength that falls in a particular range of optical wavelengths (e.g., between about 100 nm to about 1 mm, or some subrange thereof), also referred to as optical waves, light waves, or simply light. In some implementations, optical waves can be associated with one or more optical modes or spatial modes. In some implementations, an optical mode can be associated with a structure that is configured to guide an optical wave.

### SUMMARY

In one aspect, in general, an apparatus comprises: a plurality of optical processing stages configured to process two or more optical waves having a spectral peak wavelength, λ, wherein each of two or more of the plurality of optical processing stages comprises: two or more configurable optical structures that are substantially coplanar with a plane, where each configurable optical structure is configured to receive an optical wave propagating along a first axis that is substantially parallel to the plane and each configurable optical structure comprises an active region having: a width along a second axis that is substantially parallel with the plane and perpendicular to the first axis, where the width is less than or equal to 2λ, a height along a third axis that is substantially perpendicular to the plane and perpendicular to the first axis, where the height is greater than λ/10, and a length along the first axis that is less than or equal to 100λ; and an interface region configured to receive optical waves from each configurable optical structure in the two or more configurable optical structures; wherein each interface region associated with a respective optical processing stage of at least two of the plurality of optical processing stages is configured to couple at least a portion of an optical wave received from at least one configurable optical structure to at least two configurable optical structures in a subsequent optical processing stage.

Aspects can include one or more of the following features.

Each active region is configured to guide up to four spatial modes associated with an optical wave.

Each active region is configured to contain a respective percentage of electromagnetic power associated with an optical wave propagating through the respective active region that is greater than 50% relative to a total electromagnetic power associated with the optical wave propagating through the configurable optical structure that comprises the respective active region.

Each active region is configured to contain a percentage of electromagnetic power associated with an optical wave propagating through the respective active region that is greater than 70% relative to a total electromagnetic power associated with the optical wave propagating through the configurable optical structure that comprises the respective active region.

At least a portion of each active region of a respective optical processing stage is separated from at least a portion of one or more other active regions of the respective optical processing stage by a portion of a region comprising an insulating material.

Each region comprising an insulating material extends along a respective axis that is substantially perpendicular to the plane and parallel to the third axis below a respective surface of each adjacent active region.

At least a portion of each active region of a respective optical processing stage is separated from at least a portion of one or more other active regions of the respective optical processing stage by a respective air-insulated gap.

Each interface region comprises a slab-mode waveguiding structure formed within a substrate, where the slab-mode waveguiding structure is coupled to a plurality of configurable optical structures at a first end and the slab-mode waveguiding structure is coupled to a plurality of configurable optical structures at a second end opposite the first end.

Each configurable optical structure in the two or more configurable optical structures is configured to provide an intensity change of an optical wave propagating through each respective active region with one or more of the intensity changes providing an optical gain to the optical wave.

The optical gain that each configurable optical structure is configured to provide to an optical wave is nonlinear in an intensity of the optical wave.

At least one configurable optical structure is able to be configured to transmit at least a portion of one or more optical waves in a first mode of operation and is able to be configured to detect an intensity of an optical wave in a second mode of operation.

Each active region of the configurable optical structures comprises a first semiconductor material.

Each configurable optical structure further comprises a first layer comprising a first semiconductor material, a second layer comprising the active region, where the active region comprises a second semiconductor material, and a third layer comprising a third semiconductor material, wherein the second layer is between the first layer and the third layer.

The second layer further comprises a fourth layer comprising a fourth semiconductor material, where the fourth layer is between the first layer and the active region, and a fifth layer comprising the fourth semiconductor material, where the fifth layer is between the third layer and the active region.

The fourth semiconductor material comprises a composition of indium gallium arsenide phosphide.

A portion of the active region comprises a quantum well.

A portion of the active region comprises a bulk semiconductor material.

The first layer comprises the first semiconductor material with dopants mixed within and the third layer comprises the third semiconductor material with dopants mixed within.

Either (1) the dopants of the first layer comprise p-type dopants and the dopants of the third layer comprise n-type dopants or (2) the dopants of the first layer comprise n-type dopants and the dopants of the third layer comprise p-type dopants.

The first semiconductor material and the third semiconductor material each comprise a composition of indium gallium arsenide phosphide.

The second semiconductor material comprises a composition of indium gallium arsenide phosphide.

A respective optical wave is provided to each configurable optical structure of an optical processing stage of the plurality of optical processing stages.

The respective optical wave is provided to each configurable optical structure by a respective modulator.

At least a first active region is configured to control an optical property associated with an optical wave propagating through the first active region.

The optical property that the first active region is configured to control is an optical power associated with an optical wave propagating through the first active region.

The first active region is configured to increase an optical power associated with an optical wave propagating through the first active region.

The first active region comprises a semiconductor material having a bandgap energy that is lower than an energy associated with the spectral peak wavelength, λ, of the two or more optical waves.

The semiconductor material is a direct bandgap semiconductor material.

The first active region is configured to control an optical property associated with an optical wave propagating through the first active region based at least in part on an electro-optic effect or a thermo-optic effect.

Each active region comprises a material that is configured to control an optical property associated with an optical wave traveling through the respective active region based at least in part on a nonlinear susceptibility associated with the material.

Each active region is configured to control an optical property associated with an optical wave by one or more of the following electro-optic effects: (1) a Franz-Keldysh effect, (2) a quantum-confined Stark effect, (3) a Pockels effect, (4) a plasma dispersion effect or (5) a Kerr effect.

Each interface region consists essentially of a passive material.

In another aspect, in general, an apparatus comprises: an integrated circuit device comprising a first layer comprising a metal, a second layer comprising a first semiconductor material, a third layer comprising an active region of a second semiconductor material, and a fourth layer comprising a third semiconductor material, wherein the second layer is between the first layer and the third layer, and the third layer is between the second layer and the fourth layer; an optical interface configured to provide two or more optical waves into different respective portions of the active region along different respective propagation axes that are substantially parallel to each other including at least a first propagation axis and a second propagation axis; a plurality of metal contacts in electrical communication with the fourth layer, wherein a first subset of the metal contacts is arranged along the first propagation axis, and a second subset of the metal contacts is arranged along the second propagation axis; and an electrical source configured to apply a respective electric field between the first layer and each metal contact of the plurality of metal contacts.

Aspects can include one or more of the following features.

The first layer is in electrical communication with the second layer.

The second layer further comprises dopants mixed within the first semiconductor material and the fourth layer further comprises dopants mixed within the third semiconductor material.

Either (1) the dopants of the second layer comprise n-type dopants and the dopants of the fourth layer comprise p-type dopants or (2) the dopants of the second layer comprise p-type dopants and the dopants of the fourth layer comprise n-type dopants.

The first semiconductor material and the third semiconductor material comprise indium phosphide.

The second semiconductor material comprises a composition of indium gallium arsenide phosphide.

The fourth layer further comprises a plurality of regions of the third semiconductor material having dopants mixed within, where each metal contact of the plurality of metal contacts is in electrical communication with at least a portion of a different respective region of the plurality of regions.

At least a portion of each region of the plurality of regions is separated from at least a portion of each other region of the plurality of regions by a portion of the third semiconductor material without dopants or by a region devoid of the third semiconductor material.

One or more of the regions devoid of the third material comprise an electrically insulating or optically transparent material.

Each portion of the active region between a metal contact of the plurality of metal contacts and first layer is configured to provide an intensity change of an optical wave propagating through the respective portion of the active region based at least in part on the respective electric field applied between the first layer and the metal contact of the plurality of metal contacts, with one or more of the intensity changes providing an optical gain to the optical wave.

The optical gain that each portion of the active region is configured to provide to an optical wave is nonlinear in an intensity of the optical wave.

The third layer further comprises a fifth layer comprising a fourth semiconductor material, where the fifth layer is between the second layer and the active region, and a sixth layer comprising the fourth semiconductor material, where the sixth layer is between the fourth layer and the active region.

The fourth semiconductor material comprises a composition of indium gallium arsenide phosphide.

A portion of the active region comprises a quantum well.

A portion of the active region comprises a bulk semiconductor material.

In another aspect, in general, an apparatus comprises: a configurable optical structure configured to receive an input optical wave propagating along a first axis, wherein the input optical wave has a spatial profile that is distributed along a second axis that is perpendicular to the first axis and a third axis that is perpendicular to the first axis and the second axis, a first optical pump beam interface configured to provide a first set of two or more optical pump beams, wherein each optical pump beam of the first set of two or more optical pump beams is directed into the configurable optical structure along a respective axis that is perpendicular to the first axis and parallel to the second axis, and a second optical pump beam interface configured to provide a second set of two or more optical pump beams, wherein each optical pump beam of the second set of two or more optical pump beams is directed into the configurable optical structure along a respective axis that is perpendicular to the first axis and parallel to the third axis.

Aspects can include one or more of the following features.

The configurable optical structure comprises a region that is at an intersection between an optical pump beam from the first set of two or more optical pump beams and an optical pump beam from the second set of two or more optical pump beams.

The configurable optical structure is configured to control an intensity of an optical wave propagating through the region by providing optical gain to an input optical wave propagating through the region.

The optical gain that the region is configured to provide to an optical wave is nonlinear in an intensity of the optical wave.

The configurable optical structure comprises a plurality of regions, where each region of the plurality of regions is at an intersection between an optical pump beam from the first set of two or more optical pump beams and an optical pump beam form the second set of two or more optical pump beams.

The configurable optical structure comprises a laser crystal or glass doped with rare-earth elements.

The input optical wave is a collimated light source.

Each optical pump beam in the first set of two or more optical pump beams comprises an optical wave having a first wavelength and each optical pump beam in the second set of two or more optical pump beams comprises an optical wave having a second wavelength, where the first wavelength and the second wavelength are determined based at least in part a material of the configurable optical structure.

Aspects can have one or more of the following advantages.

Some implementations disclosed herein can be utilized to develop artificial neural networks that can be electronically or optically configured.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a schematic diagram of an example device.

FIG. 1B is a schematic diagram of an example optical processor.

FIGS. 2A-2B are schematic diagrams of example optical processors.

FIG. 3 is a schematic diagram of an example optical processor.

FIGS. 4A-4B are prophetic plots of numerical simulations associated with a gain medium.

FIGS. 5A-5G are schematic diagrams of example optical processors.

FIGS. 6A-6B are schematic diagrams of an example optical processor.

FIGS. 7A-7B are schematic diagrams of an example optical processor.

FIG. 7C is a schematic diagram of an example energy level diagram.

FIGS. 8A-8F are schematic diagrams of example devices.

FIG. 9 is a schematic diagram of an example device.

FIGS. 10A-10B are schematic diagrams of example optical processors.

### DETAILED DESCRIPTION

Some ANNs are computational models comprising layers of interconnected nodes, or neurons. Some ANNs comprise multiple layers of nodes, such as an input layer, hidden layer, and output layer. Some input layers can be configured to receive and assign data to neurons. Some hidden layers can perform computations on the input data. In some examples, this computation can comprise receiving inputs from neurons in a previous layer and applying some mathematical operations. Some mathematical operations can comprise applying weights to determine an influence of an input on an output. Some output layers can produce a final prediction or result. In some examples, this prediction can be associated with a probability distribution of a plurality of results, wherein each result is associated with a respective weight. In some examples, data associated with each of the layers can be represented by vectors.

Some implementations of artificial neural networks can comprise optical components configured to emulate the neural network. Some optical neural networks can be fabricated on photonic integrated circuits that allow light to propagate within slab-mode waveguides. Some slab-mode waveguides can comprise diffractive elements that can disrupt the propagation of light, acting as a surrogate for the neurons within an artificial neural network. In some implementations, the elements can be physically separated such that the physical separation among elements, coupled with the phase induced by the diffractive elements, can serve as a surrogate for the weights within a conventional neural network. Light can be detected at the end of the slab to determine the output of the photonic neural network's calculation. Such photonic neural networks can be useful in addressing a challenge associated with photonic computing, namely eliminating discrete photonic elements such that the physical size of a computational unit can be reduced.

Without using the methods disclosed herein, some diffractive optical neural networks can have (1) lithography-defined neurons which can fix the computation, and (2) linear diffractive propagation, which can limit the effective depth of the neural network to one layer. In some implementations, a re-programmable diffractive optical neural network can emulate a non-linear activation function associated with a conventional neural network.

Some diffractive optical neural networks comprise photonic elements designed to emulate the input layer, the hidden layers, and the output layer of an artificial neural network. In some implementations, a diffractive optical neural network can be constructed out of materials that exhibit optical gain to enable a reconfigurable photonic Artificial Intelligence (AI) processor. In some examples, a diffractive optical neural network can comprise a multimode medium, such as a slab-mode waveguide or free space. In some examples, the multimode medium can be two-dimensional (2D) or three-dimensional (3D). Allowing light to propagate in a multimode medium can overcome a challenge associated with photonic computing, which is the size of photonic elements in comparison to the size of a transistor. In some implementations, incorporating optical gain into the propagation medium can allow the weights of the diffractive optical neural network to be reprogrammed after fabrication for training or operation. Incorporating gain can also allow photonic emulation of non-linear neuron activation functions within the propagation medium. In some implementations, this emulation can allow for the representation of artificial neural networks with more than one hidden layer. Some optical architectures can comprise reconfigurable or active elements and can be configured as diffractive optical neural networks. Some diffractive optical neural networks can be referred to as an Active Diffractive Optical Neural Network (ADONN). Some optical architectures can be fabricated in 2D on a photonic integrated circuit. In some implementations, an optical architecture can also be extended into a 3D structure. In such implementations, use of a 3D structure can be associated with increased input vector sizes, output vector sizes, and computational power compared to other examples.

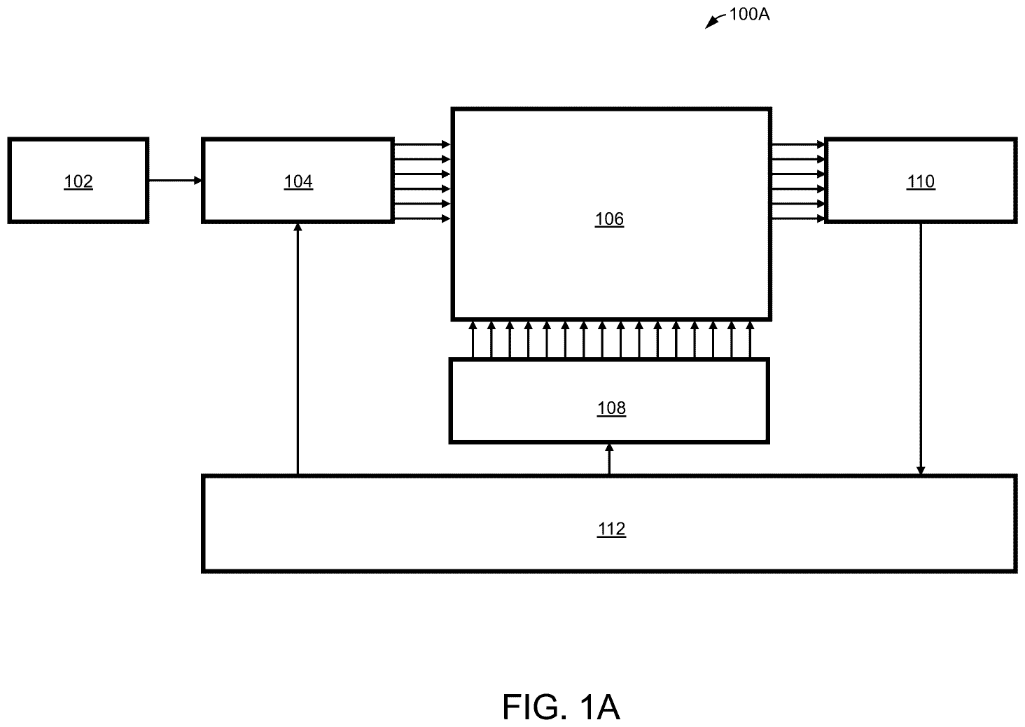

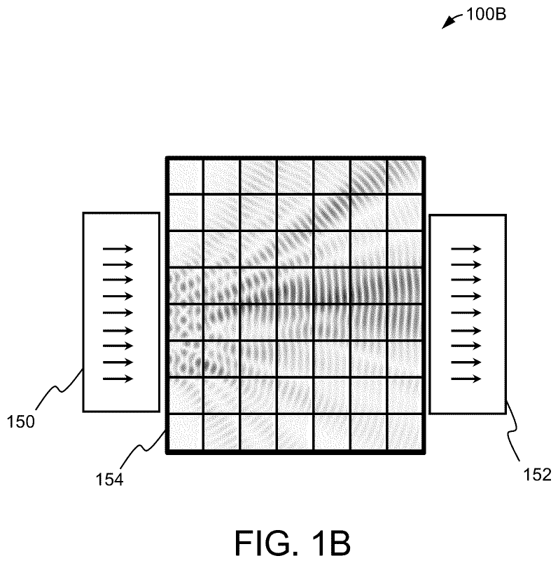

FIG. 1A depicts an example system 100A that can be implemented as an artificial neural network. The system 100A comprises one or more light sources 102 that can generate optical waves or photons and one or more modulators 104 that receive optical photons from the one or more light sources 102. The photons can be grouped into an array of inputs to a processor 106 and can represent a numerical vector input to a neural network. In other words, in some examples, the one or more light sources 102 and the one or more modulators 104 can be associated with an input layer of an artificial neural network. The one or more modulators 104 can encode a signal at each vector input into a property of the light's electric field, such as amplitude. The optical vector inputs are injected into an optical processor 106. A pumping unit 108 spatially controls pumping within the optical processor 106. This spatial pumping can be associated with one or more hidden layers of a neural network. A plurality of detectors 110 detect light at the output of the optical processor 106 and a signal from each detector can be decoded into a vector output of a neural network. The detectors 110 can be associated with the output layer of a neural network. In some implementations, electronic circuitry 112 can be configured to control components of the system 100A.

FIG. 1B depicts an example implementation 100B of an artificial neural network. The example implementation 100B comprises a plurality of input beams 150 and a plurality of output beams 152. In some examples, the plurality of input beams 150 can represent a vector of inputs to a neural network, where the inputs can be encoded in the intensity of light. In some examples, the plurality of input beams 152 can represent a vector of outputs from a neural network, where the outputs can be encoded in the intensity of light. A gain medium 154 is configured to spatially vary attenuation or gain associated with light propagating through the gain medium 154. By way of example, the gain medium 154 contains a prophetic plot of numerical simulations of light propagating through the gain medium 154.

In some examples, a propagation time of light from the input to the output of a neural network can set a latency for the processor. In some implementations, one or more optical architectures configured as ADONNs can be cascaded to increase the number of layers, number of inputs, and/or number of outputs of the neural network.

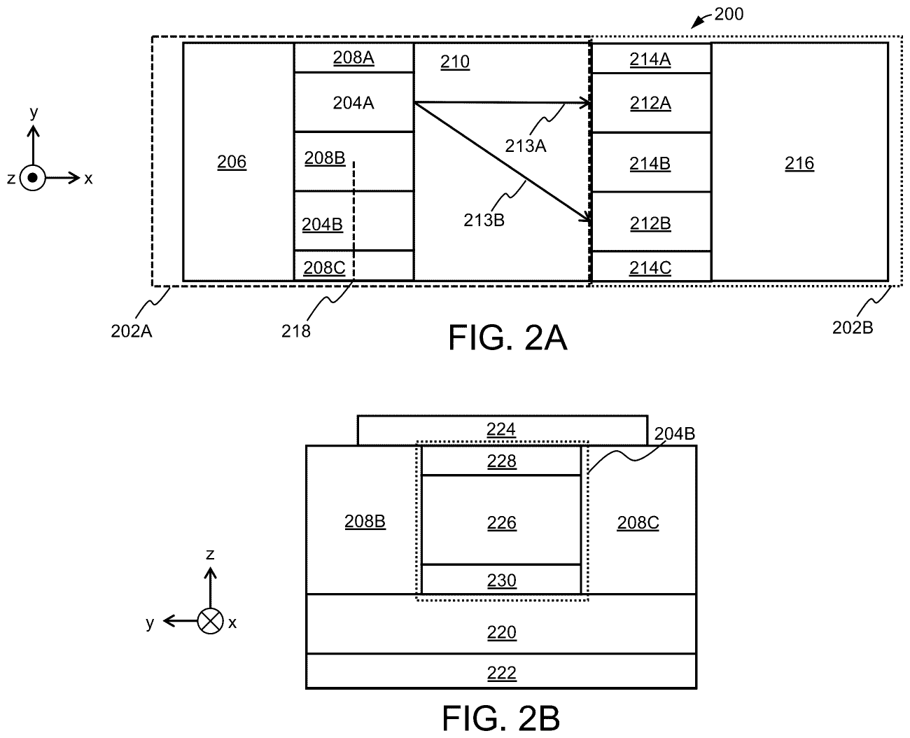

FIG. 2A depicts a top view of an example optical architecture 200 that can be used as an optical processor. The optical architecture 200 comprises two optical processing stages 202A, 202B configured to process two or more optical waves having a spectral peak wavelength, λ. The first optical processing stage 202A comprises two configurable optical structures 204A, 204B that are substantially coplanar with a plane, in this example, the xy plane. Each configurable optical structure 204A, 204B is configured to receive an optical wave propagating along a first axis that is substantially parallel to the plane, in this example, the x axis. In this example, the configurable optical structures 204A, 204B each receive an optical wave from an optical interface 206. The configurable optical structures 204A, 204B are separated by insulating regions 208A-208C. The first optical processing stage 202A further comprises an interface region 210 configured to receive optical waves from each configurable optical structure 204A, 204B. The second optical processing stage 202B comprises two configurable optical structures 212A, 212B separated by insulating regions 214A-214C. The second optical processing stage 202B further comprises an interface region 216 configured to receive optical waves from each of the configurable optical structures 212A, 212B. The interface region 210 associated with the first optical processing stage 202A is configured to couple at least a portion of an optical wave received from at least one configurable optical structure 204A, 204B to at least two configurable optical structures 212A, 212B in the subsequent optical processing stage 202B. By way of example, portions of an optical wave 213A, 213B are each coupled from the configurable optical structure 204A into the configurable optical structures 212A, 212B, respectively. In some implementations, insulating regions that are adjacent to each active region can comprise an optically transparent material and/or an electrically insulating material. In some implementations, each active region can be separated by an insulating region comprising an air-insulated gap. Such an air-insulated gap can be formed, for example, by etching into a substrate in which the active regions are formed.

Each configurable optical structure 204A, 204B and 212A, 212B can comprise an active region. FIG. 2B depicts a two-dimensional perspective view of the optical architecture 200 along plane 218. The optical architecture 200 comprises a substrate material 220 forming a layer and a shared bottom side contact 222 forming another layer. The optical architecture 200 also comprises a top side contact 224 that is associated with the configurable optical structure 204B. In some implementations, each configurable optical structure 204A, 204B, 212A, 212B can be associated with a different respective top side contact. The configurable optical structure 204B comprises a layer 226, a layer 228 and a layer 230. In some examples, the layer 226 can comprise an active region. In some implementations, the layer 228 can comprise p-type dopants and the layer 230 can comprise n-type dopants. In some implementations, the layer 228 can comprise n-type dopants and the layer 230 can comprise p-type dopants. In some implementations, each insulating region 208B, 208C can extend below a layer 226 that contains the active region such that the active regions are “deep-etched.” As shown in FIG. 2B, in some implementations, an insulating region 208B, 208C can extend below a respective surface of an adjacent active region of the layer 226.

In some implementations, the active region of the layer 226 can be configured to guide one or more modes associated with an optical wave. In some implementations, the active region of the layer 226 can have a width of less than or equal to 2λ along a second axis that is substantially parallel with the plane and perpendicular to the first axis. In this example, the second axis is the y axis. The active region of the layer 226 can have a height greater than λ/10 along a third axis that is substantially perpendicular to the plane and perpendicular to the first axis. In this example, the third axis is the z axis. The active region of the layer 226 can have a length less than or equal to 100λ along the first axis that is substantially parallel with the plane and parallel with the first axis. In some implementations, tailoring the dimensions of the active region of the layer 226 can allow up to four modes associated with an optical wave to be guided by the active region 226.

In some implementations, tuning the geometry of an active region can increase an optical confinement factor associated with guiding an optical wave through the active region. An optical confinement factor can describe the amount or percentage of electromagnetic power contained within the active region. Some active regions can be configured such that a percentage of electromagnetic power associated with an optical wave or optical mode propagating through the active region is greater than 50% or greater than 70% relative to a total electromagnetic power associated with the optical wave propagating through the configurable optical structure that comprises the respective active region. In some examples, tuning the geometry of an active region can provide increased gain associated with an optical wave propagating through the active region.

In some implementations, the layer 226 can comprise a fourth layer comprising a fourth semiconductor material, where the fourth layer is between the first layer and the active region, and a fifth layer comprising the fourth semiconductor material, where the fifth layer is between the third layer and the active region. In some examples, a portion of the active region of the layer 226 can comprise a quantum well or a bulk semiconductor material.

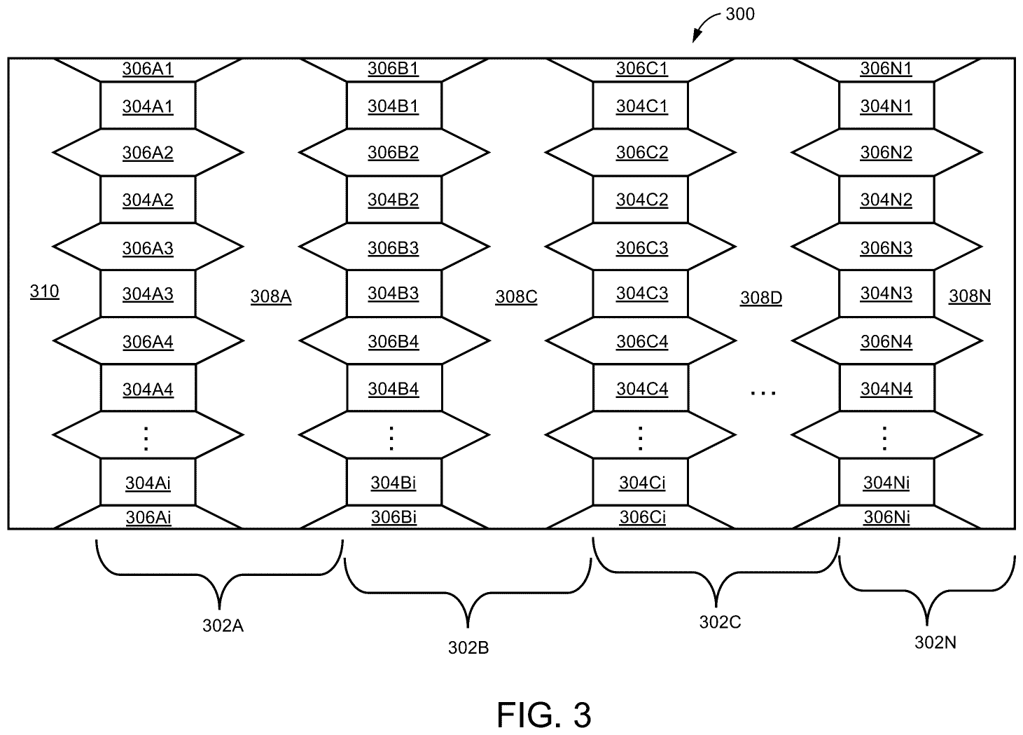

FIG. 3 depicts an example optical architecture 300 that can be used as an optical processor. The optical architecture 300 comprises a plurality of optical processing stages 302A-302N. Each optical processing stage 302A-302N is configured to process two or more optical waves having a spectral peak wavelength, λ. Each of the optical processing stages 302A-302N comprises two or more configurable optical structures 304Ai-304Ni, where i is a number of configurable optical structures within each optical processing stage 302A-302N. Each configurable optical structures 304Ai-304Ni is separated by an insulating region 306Aj-306Nj, where j is a number of insulating regions within each optical processing stage 302A-302N. Each optical processing stage 302A-302N further comprises an interface region 308A-308N configured to couple at least a portion of an optical wave received from at least one configurable optical structure 304Ai-304Ni to at least two configurable optical structures 304Ai-304Ni in a subsequent optical processing stage 302A-302N. The first optical processing stage 310 is configured to receive optical waves from a coupler 310.

In some implementations, one or more of the interface regions 308A-308N can be devoid of an active region such that the interface region 308A-308N is passive and does not control an intensity of an optical wave propagating through the respective interface region 308A-308N according to any control signals. Instead, the intensity (or other characteristics, such as phase) may undergo uncontrolled effects from simple propagation through a material, such as minor intensity reduction due to an intrinsic loss of the material.

In some implementations, a configurable optical structure can be configured to provide an intensity change of an optical wave propagating through each respective active region with one or more of the intensity changes providing optical gain to the optical wave. In some implementations, the optical gain that each active region is configured to provide to an optical wave can be nonlinear in an intensity of the optical wave.

In some implementations, an active region can be configured to control an optical property associated with an optical wave propagating through the respective active region. For instance, an active region can control an optical property such as optical power or intensity through processes such as stimulated emission or absorption. Some active regions can be configured to increase or decrease an intensity associated with an optical wave propagating through the active region. Other optical properties that can be controlled by an active region include optical phase, optical wavelength, and polarization. Some active regions can also be configured to convert power from one optical wavelength or mode to another through nonlinear conversion.

Some active regions can control an optical property based at least in part on a control signal. Some examples of control signals that can be associated with an active region include optical or electrical pumping, mechanical deformation, and temperature. Some examples of optical pumping can be associated with an optical power applied to an active region. In some examples, electrical pumping can be associated with an electrical power, current, or voltage applied to an active region.

Some active regions can control an optical property based at least in part on an applied electrical field characterized by an electro-optic effect. Examples of electro-optical effects include: (1) the Franz-Keldysh effect, (2) the quantum-confined Stark effect, (3) the Pockels effect, (4) the plasma dispersion effect or (5) the Kerr effect. In some examples, an electro-optic effect can be associated with a nonlinear property, such as a nonlinear optical susceptibility, of a material. For instance, the Pockels effect, sometimes called the linear electro-optic effect, can be associated with a χ⁽²⁾ electric susceptibility of a material. The Kerr effect, sometimes called the quadratic electro-optic effect, can be associated with a χ⁽³⁾ electric susceptibility of a material. In some examples, a nonlinear material can control an optical property associated with an optical mode, such as optical phase, based at least in part on an external electrical field through an electro-optic effect such as the Kerr effect. Some active regions can control an optical property of an optical mode based at least in part on an applied temperature modulation through the thermo-optic effect or an acoustic wave through the acousto-optic effect.

Some active regions can be configured to control an optical power or intensity associated with an optical wave using properties associated with a semiconductor material. Some active regions can comprise semiconductor materials having a bandgap energy that is lower than the photon energy of an optical wave propagating through the active region. Some semiconductor materials have band structures associated with electrons in the semiconductor. In some examples, a band structure can be expressed as a function of a crystal momentum associated with electrons in a crystal lattice. In some examples, a semiconductor material can have a direct band gap, wherein electrons in a valence band can be excited to a conduction band without a change in the crystal momentum.

In some implementations, a configurable optical structure is able to be configured to transmit at least a portion of one or more optical waves in a first mode of operation and is able to be configured to detect an intensity of an optical wave in a second mode of operation. In some implementations, configuring configurable optical structures to detect intensities of optical waves can simplify optical architecture designs, as photodetectors can be omitted. In some implementations, configurable optical structure configured to detect intensities can provide feedback during neural network training, calibration, operation, or processing.

In some implementations, the amount of gain or absorption at each location in an optical architecture configured as an optical processor can represent weights associated with a hidden layer of a neural network, and the propagation of light can serve as both an interconnect among neurons and the mechanism for calculations. In some implementations, an optical processor can comprise a gain medium. Some gain mediums can be strong absorbers of a designed gain wavelength when the gain medium is not pumped. As the strength of pumping is increased, an increasing fraction of carriers can be excited from the ground state into higher energy-level states. This excitation can simultaneously reduce the number of carriers that are available for stimulated recombination and increase the number of carriers available for stimulated emission. In some examples, the excitation can eventually make the material transparent and then at strong enough pump levels, an amplifier. Some gain mediums can be pumped electrically and some gain mediums can be pumped optically. In some materials that can be pumped electrically, the current density can be varied across the propagation medium and in materials that are pumped optically, the strength of pump light can be varied across the material to vary the absorption/gain coefficient of the propagation medium.

In some implementations, the strength of an electrical or optical pump can be rapidly and digitally controlled. This control can allow an ADONN to electronically reconfigure the weights of the neural network. Reconfiguration of the network can be useful both to train the neural network and to change the computational function of the neural network.

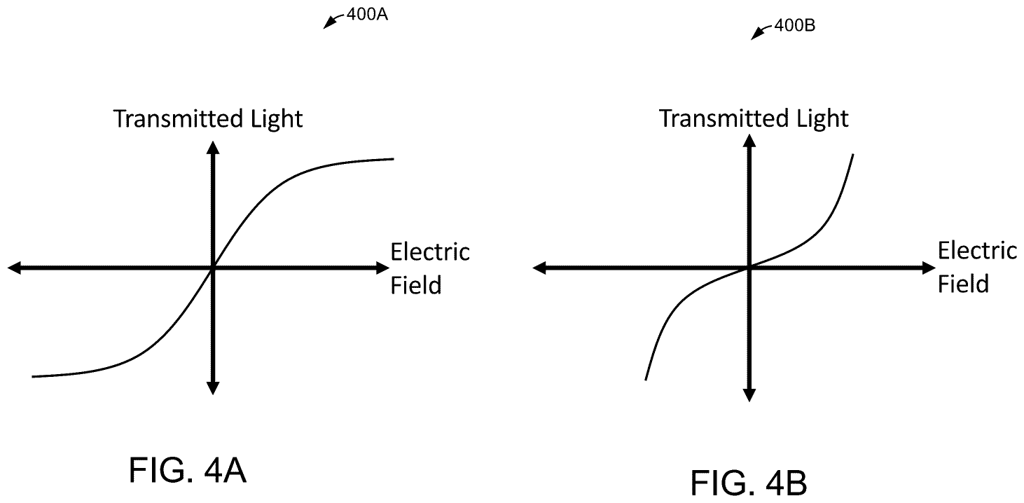

In some implementations, a gain material can serve as a non-linear activation function. At high fluence, some gain materials can exhibit saturation effects in both the absorption regime and the gain regime. In the absorption regime, this effect can be referred to as saturable absorption, whereas in the gain regime, this effect can be referred to as gain saturation. FIG. 4A depicts a prophetic plot 400A of a numerical simulation of transmitted light as a function of electric field in the gain regime. FIG. 4B depicts a prophetic plot 400B of a numerical simulation of transmitted light as a function of electric field in the absorption regime. From the perspective of an area of gain medium serving as a neuron in an ADONN, gain saturation can cause a roll-off in activation for both strong positive and negative values, which can be similar to a hyperbolic tangent activation function.

In some implementations, detectors can also serve as a non-linear activation function. Whereas propagation in the medium can operate on the electric field of light, photodiodes and other optical detectors can generate a signal proportional to the power of light, which may not be less than zero. This signal can result in a non-linearity that is similar to a Rectified Linear Unit (ReLU) activation function.

In some implementations, the input modulators can be eliminated and instead the pump strength applied at the beginning of the gain medium can be used to encode the strength of the input signal. This encoding can eliminate the need for discrete light sources or modulators. Instead, a single light source can be distributed across the array.

In some implementations, as an alternative to a gain medium, a material that only attenuates can be used. For instance, a slab-mode PN junction can be used. The current density can be varied across the slab waveguide to spatially modulate the absorption coefficient of the propagation medium. This implementation can offer the advantage that the propagation medium can be defined natively within silicon photonic processes. In some examples, sufficient optical power can be provided at the input of the network to overcome the losses that can be accumulated in the slab mode waveguide.

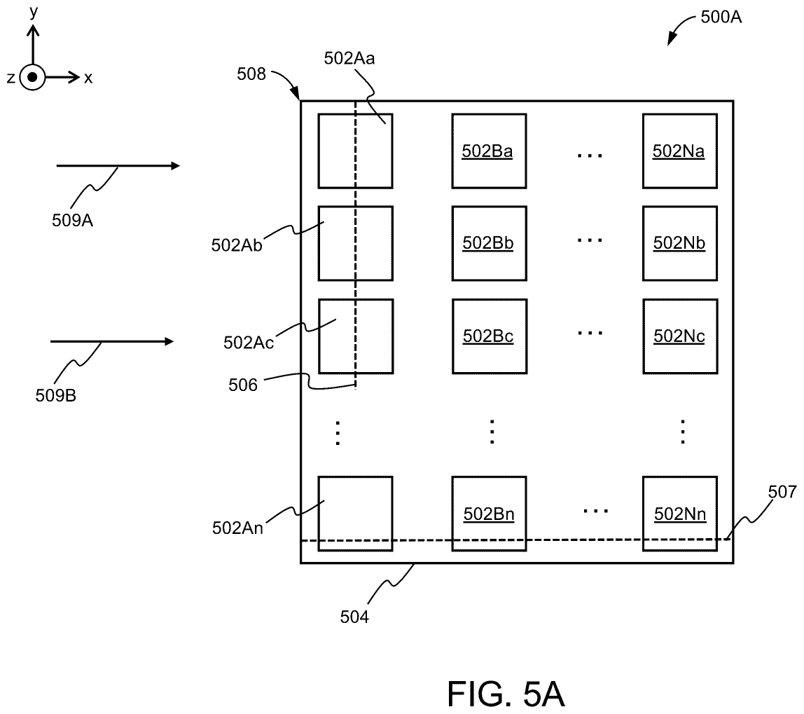

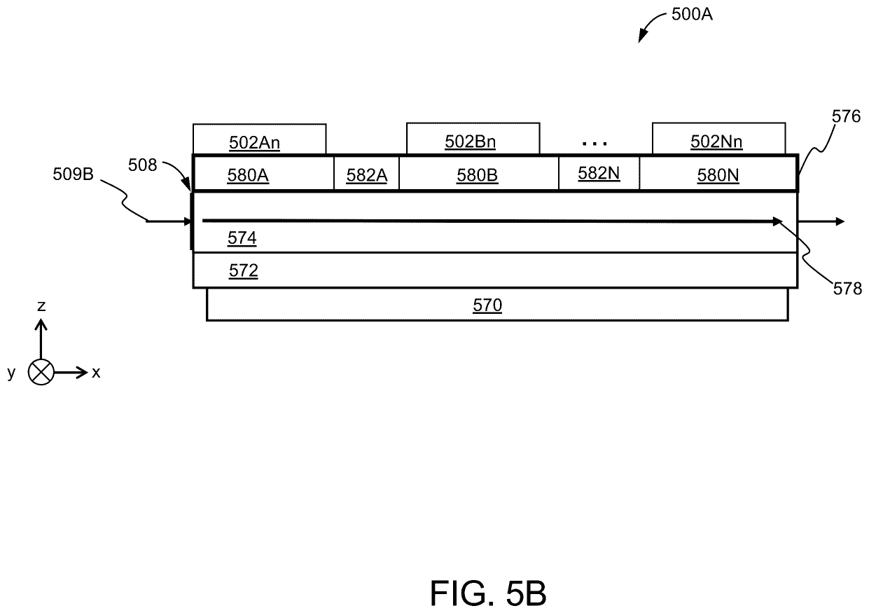

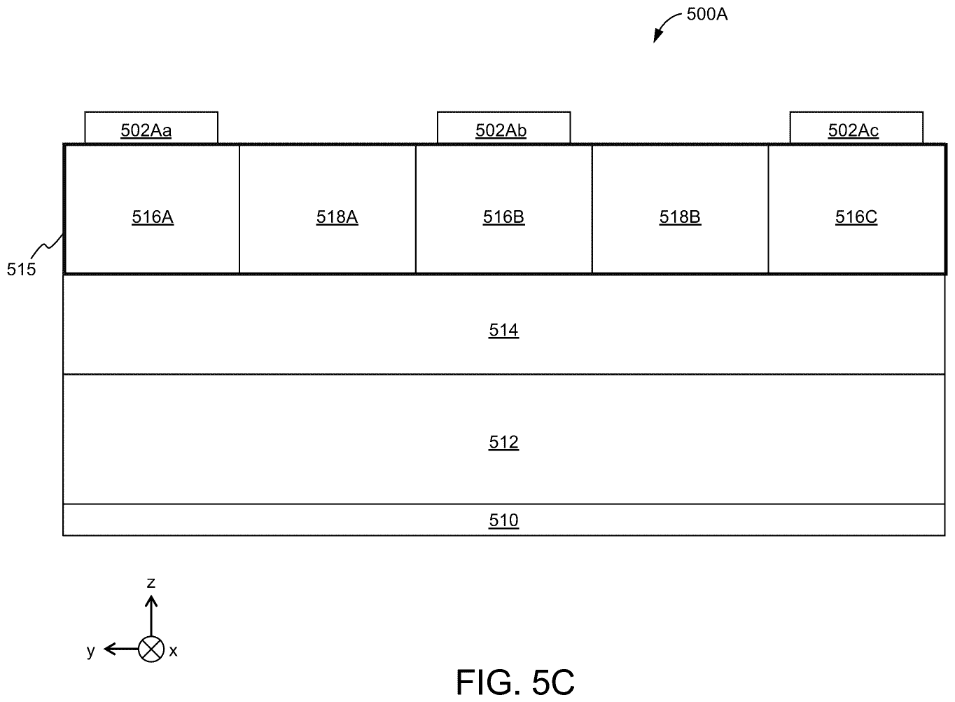

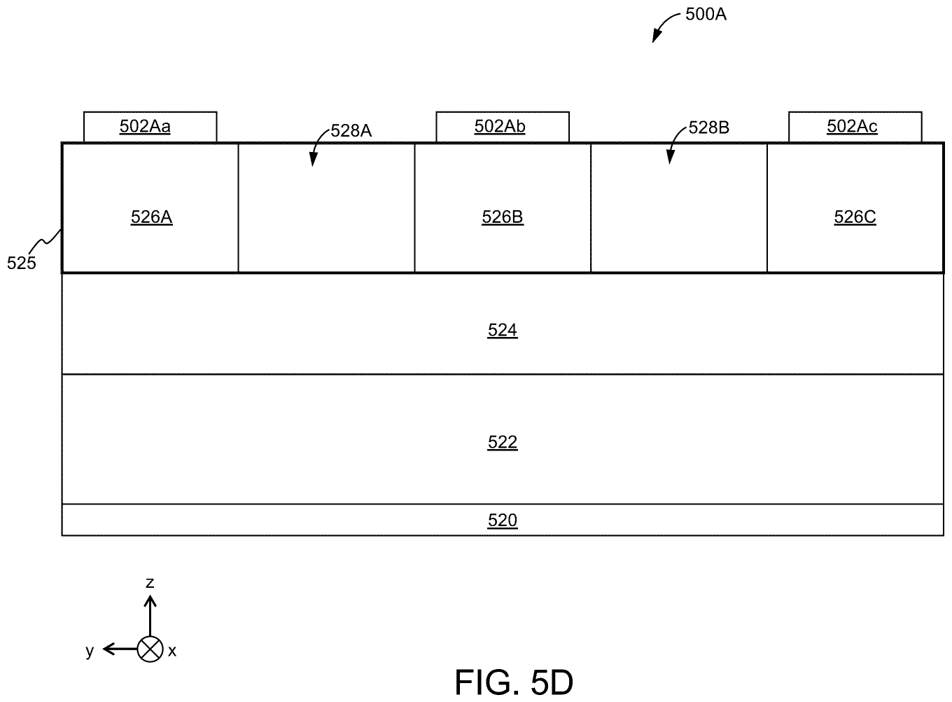

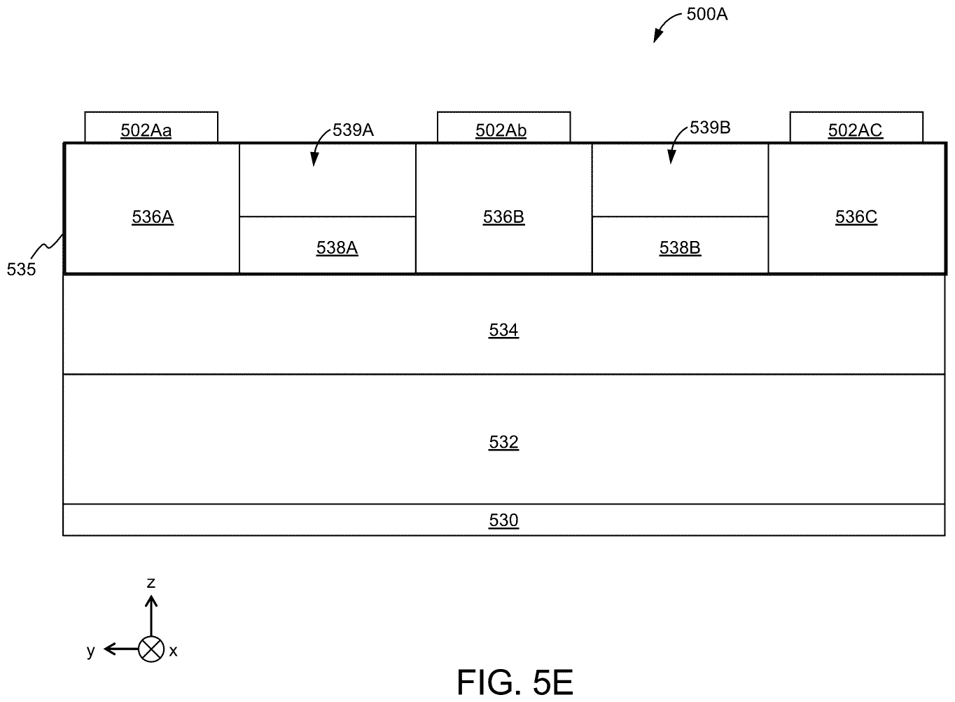

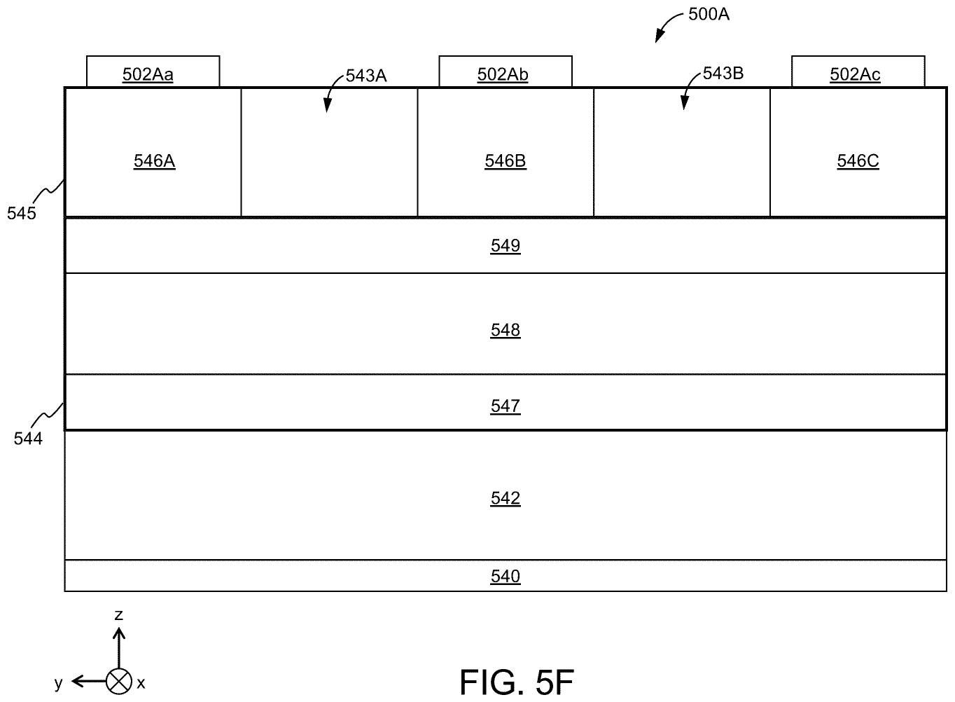

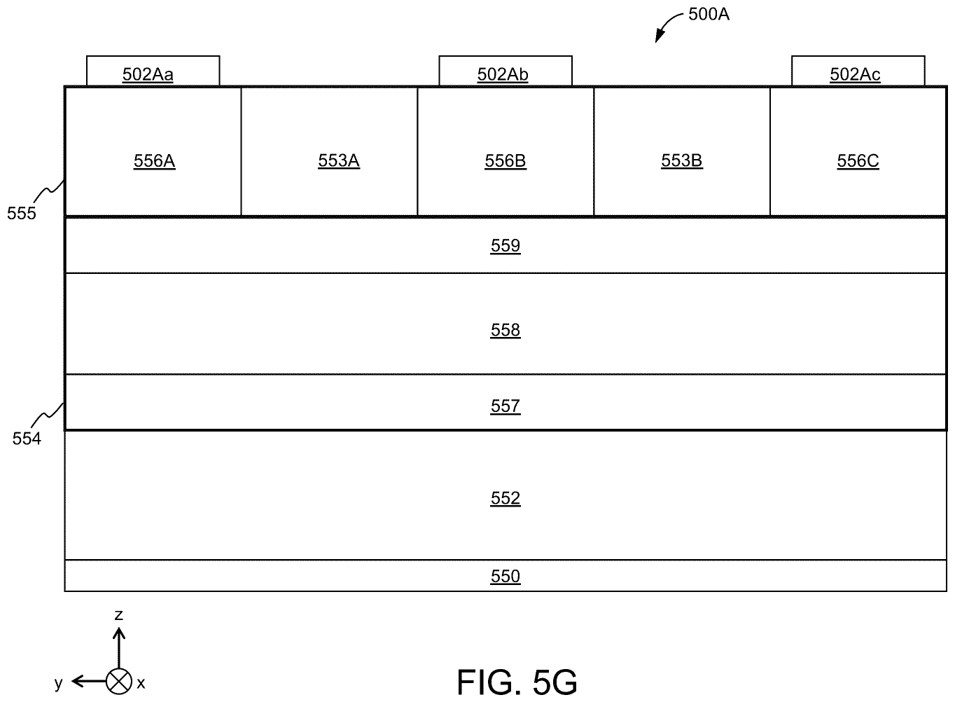

In some implementations, an optical architecture can be configured to provide localized gain control of an optical gain medium comprising a slab-mode waveguide. FIG. 5A depicts a top view of an optical architecture 500A that can be used as an optical processor. The optical architecture 500A comprises a plurality of metal contacts 502Aa-502Nn arranged over a surface 504. The optical architecture 500A further comprises an optical interface 508 configured to provide two or more optical waves 509A, 509B into different respective portions of the active region along different respective propagation axes that are substantially parallel to each other including at least a first propagation axis and a second propagation axis. The plurality of metal contacts 502Aa-502Nn comprises a first subset of metal contacts 502Aa-502Na arranged along the first propagation axis and a second subset of metal contacts 502An-502Nn arranged along the second propagation axis.

In some examples, an optical architecture can comprise one or more layers configured to provide gain control.

FIG. 5B depicts an example two-dimensional perspective view of the optical architecture 500A along plane 507. In this example, the optical architecture 500A comprises a first layer 570 comprising metal, a second layer 572 comprising a first semiconductor material, a third layer 574 comprising an active region of a second semiconductor material, and a fourth layer 576 comprising regions 580A-580N in electrical contact with the plurality of metal contacts 502An-502Nn. The regions 580A-580N are separated by regions 582A-582N. The plurality of metal contacts 502An-502Nn is arranged on the fourth layer 576. The optical interface 508 is configured to receive the optical wave 509B, which propagates 578 through the third layer 574. In some examples, the optical interface 508 can comprise a waveguide junction or doped glass.

FIG. 5C depicts an example two-dimensional perspective view of the optical architecture 500A along plane 506. In this example, the optical architecture 500A comprises a first layer 510 comprising metal, a second layer 512 comprising a first semiconductor material, a third layer 514 comprising an active region of a second semiconductor material, and a fourth layer 515 comprising regions 516A-516C separated by regions 518A, 518B. In this example, the third layer 514 is the active region of the second semiconductor material. The plurality of metal contacts 502Aa-502Ac is arranged on the fourth layer 515. The fourth layer 515 comprises a third semiconductor material. Each metal contact 502Aa-502Ac is associated with a region 516A-516C. In some implementations, the regions 516A-516C can comprise the third semiconductor material with dopants mixed within and the regions 518A, 518B can comprise the third semiconductor material without dopants mixed within. In some examples, the dopants can be p-type dopants. In some implementations, the second layer 512 can comprise the first semiconductor material with dopants mixed within. In some examples, the dopants can be n-type. The second layer 512 is between the first layer 510 and the third layer 514, and the third layer 514 is between the second layer 512 and the fourth layer 515.

FIG. 5D depicts an example two-dimensional perspective view of the optical architecture 500A along plane 506. In this example, the optical architecture 500A comprises a first layer 520 comprising metal, a second layer 522 comprising a first semiconductor material, a third layer 524 comprising an active region of a second semiconductor material, and a fourth layer 525 comprising a third semiconductor material. The fourth layer 525 comprises regions 526A-526C separated by regions 528A, 528B devoid of the third semiconductor material. In this example, the third layer 524 is the active region of the second semiconductor material. The plurality of metal contacts 502Aa-502Ac is arranged on the fourth layer 525. Each metal contact 502Aa-502Ac is associated with a region 526A-526C. In some implementations, the regions 526A-526C can comprise the third semiconductor material with dopants mixed within. In some examples, the dopants can be p-type dopants. In some implementations, the second layer 522 can comprise the first semiconductor material with dopants mixed within. In some examples, the dopants can be n-type.

FIG. 5E depicts an example two-dimensional perspective view of the optical architecture 500A along plane 506. In this example, the optical architecture 500A comprises a first layer 530 comprising metal, a second layer 532 of a first semiconductor material, a third layer 534 comprising an active region of a second semiconductor material, and a fourth layer 535 comprising a third semiconductor material. The fourth layer 535 comprises regions 536A-536C separated by regions 538A, 538B comprising the third semiconductor and regions 539A, 539B that are devoid of the third semiconductor material. In this example, the third layer 534 is the active region of the second semiconductor material. The plurality of metal contacts 502Aa-502Ac is arranged on the fourth layer 535. Each metal contact 502Aa-502Ac is associated with a region 536A-536C. In some implementations, the regions 536A-536C and the regions 538A, 538B can comprise the third semiconductor material with dopants mixed within. In some examples, the dopants can be p-type dopants. In some implementations, the second layer 532 can comprise the first semiconductor material with dopants mixed within. In some examples, the dopants can be n-type.

As shown in FIGS. 5C-5E, at least a portion of each region of the plurality of regions of the fourth layer is separated from at least a portion of each other region of the plurality of regions by a portion of the third semiconductor material without dopants or by a region devoid of the third semiconductor material. In some implementations, the region devoid of the third semiconductor material can comprise an electrically insulating or optically transparent material. Some examples of electrically insulating or optically transparent materials include silicon dioxide (SiO₂), silicon nitride (Si₃N₄), and benzocyclobutene (BCB).

In some implementations, the third layer can comprise a fifth and sixth layer comprising a fourth semiconductor material. FIG. 5F depicts an example two-dimensional perspective view of the optical architecture 500A along plane 506. In this example, the optical architecture 500A comprises a first layer 540 comprising metal, a second layer 542 of a first semiconductor material, a third layer 544 comprising an active region 548 of a second semiconductor material, and a fourth layer 545 comprising regions 546A-546C separated by regions 543A, 542B devoid of the third semiconductor material. The third layer 544 also comprises a fifth layer 547 and a sixth layer 549 comprising a fourth semiconductor. The plurality of metal contacts 502Aa-502Ac is arranged on the fourth layer 545. The fourth layer 545 comprises a third semiconductor material. Each metal contact 502Aa-502Ac is associated with a region 546A-546C. In some implementations, the regions 546A-546C can comprise the third semiconductor material with dopants mixed within. In some examples, the dopants can be p-type dopants. In some implementations, the second layer 542 can comprise the first semiconductor material with dopants mixed within. In some examples, the dopants can be n-type.

FIG. 5G depicts an example two-dimensional perspective view of the optical architecture 500A along plane 506. In this example, the optical architecture 500A comprises a first layer 550 comprising metal, a second layer 552 of a first semiconductor material, a third layer 554 comprising an active region 558 of a second semiconductor material, and a fourth layer 555 comprising regions 556A-556C separated by regions 553A, 553B. The third layer 554 also comprises a fifth layer 557 and a sixth layer 559 comprising a fourth semiconductor material. The plurality of metal contacts 502Aa-502Ac is arranged on the fourth layer 555. The fourth layer 555 comprises a third semiconductor material. Each metal contact 502Aa-502Ac is associated with a region 546A-546C. In some implementations, the regions 546A-546C can comprise the third semiconductor material with mixed within. In some examples, the dopants can be p-type dopants. In some implementations, the second layer 552 can comprise the first semiconductor material with dopants mixed within. In some examples, the dopants can be n-type.

In some implementations, the active region 558 can be thin such that the interaction between the semiconductor material of the active region 558 and light propagating through the active region 558 can be characterized by quantum behaviors. In some implementations, these quantum behaviors can be referred to as quantum wells. Some optical architectures can comprise multiple thin layers of active regions each separated by semiconductor materials to form multiple quantum wells. In some implementations, tuning the composition of each layer, as described below, can tune physical or material properties associated with the optical architecture. In some implementations, the active region 558 can be thick such that material or optical properties of the active region 558 are associated with bulk material properties. Some active regions can comprise quantum dots, or semiconductor nanocrystals.

In some implementations, the first semiconductor material and the third semiconductor can comprise indium phosphide and the second semiconductor material can comprise a composition of indium gallium arsenide phosphide. In some implementations, the fourth semiconductor material can comprise a composition of indium gallium arsenide phosphide. In some examples, the second semiconductor material and the fourth semiconductor material can comprise different compositions of indium gallium arsenide phosphide. Some compositions of indium gallium arsenide phosphide can leave out or omit elements. In some implementations, changing ratios of elements in a composition can change a bandgap or lattice constant associated with a semiconductor material and tune optical properties associated with the semiconductor material.

In some implementations, each of the second layers in FIGS. 5B-5G can comprise the first semiconductor material with dopants mixed within. In some implementations, the dopants can be p-type. In some implementations, each of the fourth layers in FIGS. 5B-5G can comprise the third semiconductor material with dopants mixed within. In some implementations, the dopants can be n-type.

As shown in FIGS. 5A-5G, each of the plurality of metal contacts can be arranged on a surface of the fourth layer. In some examples, each of the plurality of metal contacts can be in electrical communication or electrical contact with the fourth layer or portions thereof. In some implementations, a layer comprising a metal can be in electrical communication with another layer comprising a semiconductor. In some implementations, a metal layer that is in electrical communication with a semiconductor layer can be in direct contact with the semiconductor layer. In some implementations, a metal layer that is in electrical communication with a semiconductor layer can have separating layers between the metal layer and the semiconductor layer. For instance, a thin ohmic contact layer can be placed in between the fourth layer and the plurality of metal contacts. A thin ohmic contact layer can also be placed between a first layer comprising metal and a second layer comprising a semiconductor.

In some implementations, an electrical source can be configured to apply an electric field to an optical processor. Some electrical sources can comprise a voltage source while some electrical sources can comprise a current source. In some implementations, a respective electric field can be applied between each metal contact of a plurality of metal contacts and the first layer comprising a metal. In some implementations, this electric field can comprise an alternating current (AC) or direct current (DC).

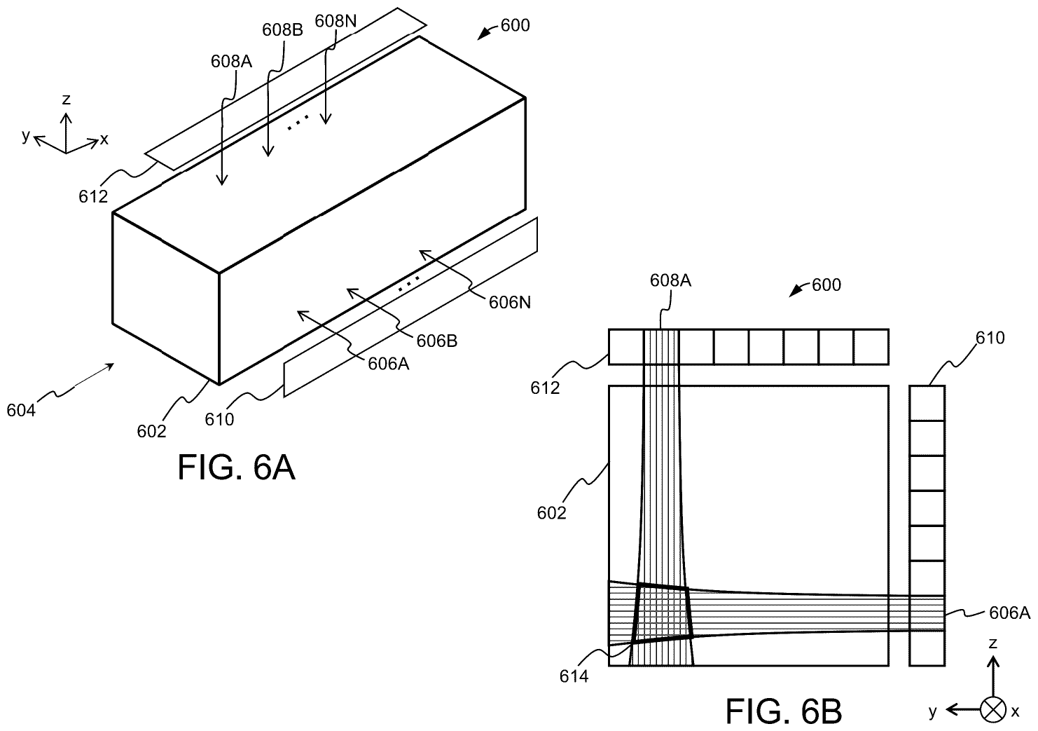

In some implementations, an optical architecture can comprise an optically pumped gain medium configured as an optical processor. FIG. 6A depicts an isometric view of an example optical architecture 600 that can be utilized as an optical processor. The optical architecture 600 comprises a configurable optical structure 602. The configurable optical structure 602 receives an input optical wave 604 propagating along a first axis, in this example, the x axis. In some examples, the input optical wave 604 can have a spatial profile that is distributed along a second axis that is perpendicular to the first axis and a third axis that is perpendicular to the first axis and the second axis. In this example, the second axis is the y axis and the third axis is the z axis. A first optical pump beam interface 610 is configured to provide a first set of two or more optical pump beams 606A-606N directed into the configurable optical structure 602 along a respective axis that is perpendicular to the first axis and parallel to the second axis. A second optical beam interface 612 is configured to provide a second set of two or more optical pump beams 608A-608N directed into the configurable optical structure 602 along a respective axis that is perpendicular to the first axis and parallel to the third axis.

FIG. 6B depicts an example two-dimensional perspective view of the optical architecture 600 along the yz plane. The configurable optical structure 602 comprises a region 614 that is at the intersection between an optical pump beam 606A from the first optical pump beam interface 610 and an optical pump beam 608A from the second optical pump beam interface 612. In some implementations, the configurable optical structure 602 can comprise a bulk gain medium, such as a laser crystal or rare-earth doped glass. Some rare-earth doped glasses can comprise dopants such as neodymium, ytterbium, erbium, thulium, cerium, titanium, or chromium. In some implementations, the configurable optical structure 602 can be configured to control an intensity of an optical wave propagating through the region by providing optical gain to an input optical wave propagating through the region 614.

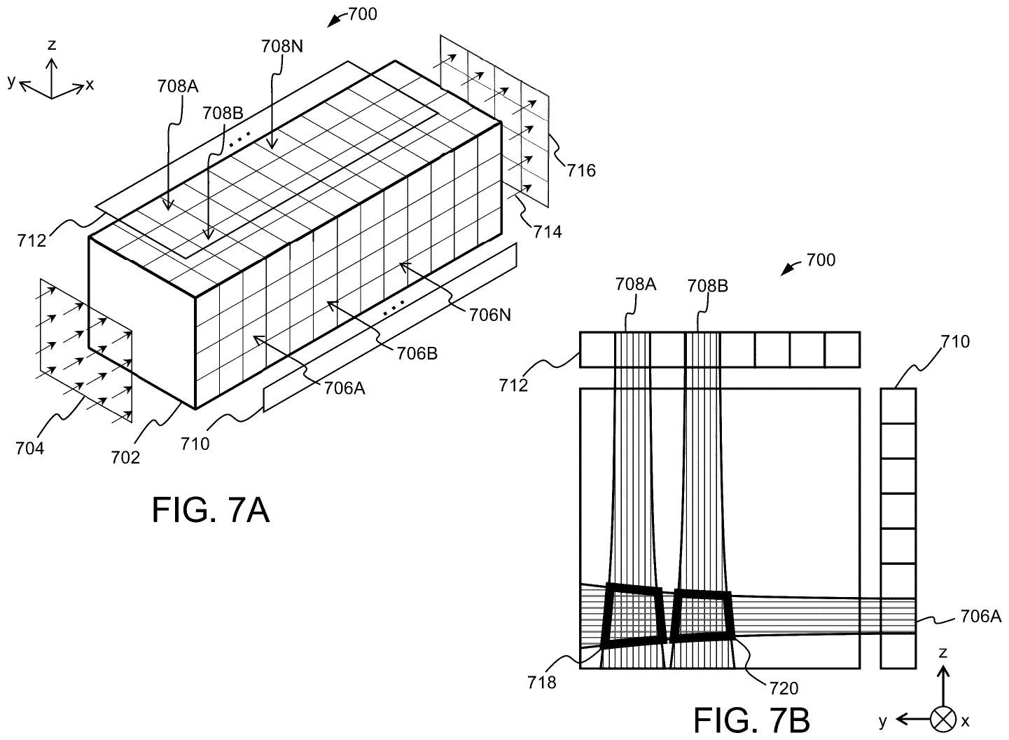

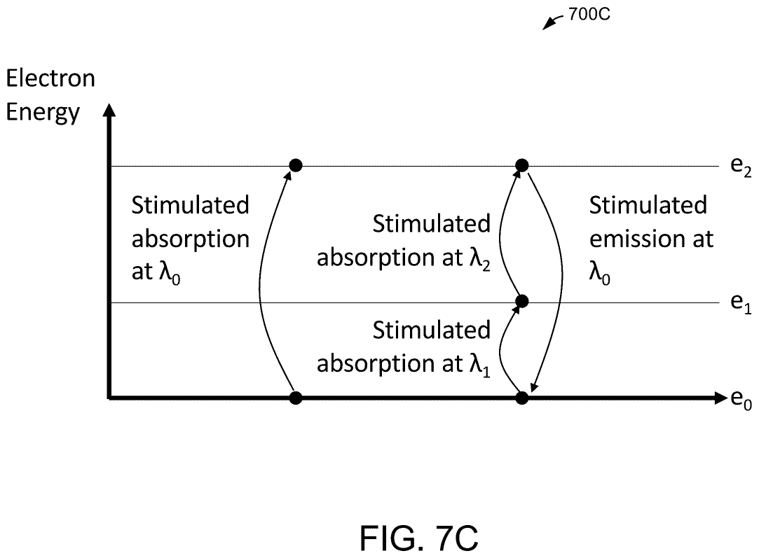

FIG. 7A depicts an isometric view of an example optical architecture 700 that can be used as an optical processor. Collimated light 704 is directed into a laser gain medium 702. A first optical pump beam interface 710 is configured to provide a first set of two or more optical pump beams 706A-706N directed into the configurable optical structure 702. A second optical beam interface 712 is configured to provide a second set of two or more optical pump beams 708A-708N directed into the configurable optical structure 702. In some examples, each optical beam interface 710, 712 can be configured to provide optical beams in a 2D array. Light propagates through the gain medium 702 and the output 714 is detected by a two-dimensional (2D) array of photodetectors 716. In some implementations, an electronic circuit (not shown) can amplify a photocurrent from the photodetectors 716 and digitize the data for further processing. In some examples, an electronic circuit (not shown) can control the strength of each optical beam in the first optical beam interface 710 and the second optical beam interface 712.

FIG. 7B depicts an example two-dimensional perspective view of the optical architecture 700 along the yz plane. The configurable optical structure 702 comprises a region 718 that is at the intersection between an optical pump beam 706A from the first optical pump beam interface 710 and an optical pump beam 708A from the second optical pump beam interface 712. The configurable optical structure 702 also comprises a region 720 that is at the intersection between an optical pump beam 706A from the first optical pump beam interface 710 and an optical pump beam 708B from the second optical pump beam interface 712. In some implementations, these regions 718, 720 can be referred to as 3D pixels, or voxels.

In some implementations, the two arrays of light sources can be used to selectively pump one or more voxels within the laser crystal. Some voxel elements can be pumped when light is simultaneously present at a first wavelength λ₁ and a second wavelength λ₂. In some optical architectures, the pumping can be controlled by careful selection of the wavelengths and gain material. For instance, a laser gain material can be used for this process that has three energy levels, e₀ [the ground state], e₁, and e₂, where e₁ can have a short carrier lifetime and e₂ can have a long carrier lifetime. FIG. 7C depicts an example energy level diagram 700C associated with a gain medium. In some implementations, input light directed to the laser gain medium can have a wavelength λ₀. In some examples, λ₀ can be chosen so that its photon energy is equal to e₂−e₀ , λ₁ can chosen so that its photon energy is equal to e₁ −e₀ and λ₂ can be chosen so that its photon energy is equal to e₂−e₁. In some examples, if light of only λ₁ is directed at a voxel, electrons in the gain material can be elevated to the e₁ state, but as soon as the pump light is removed, the short carrier lifetime can cause the electrons to decay back into the ground state. In some examples, if light of only λ₂ is directed at a voxel, the light can simply pass through the gain material. In some examples, when light of both wavelengths is present, electrons can first be pumped into state e₁ by λ₁ and then again pumped into state e₂ by λ₂. Other combinations of energy levels can also be used as well to achieve a similar effect.

In some implementations, a device comprising one or more photonic integrated circuits can be utilized as a two-dimensional, electronically or optically pumped ADONN.

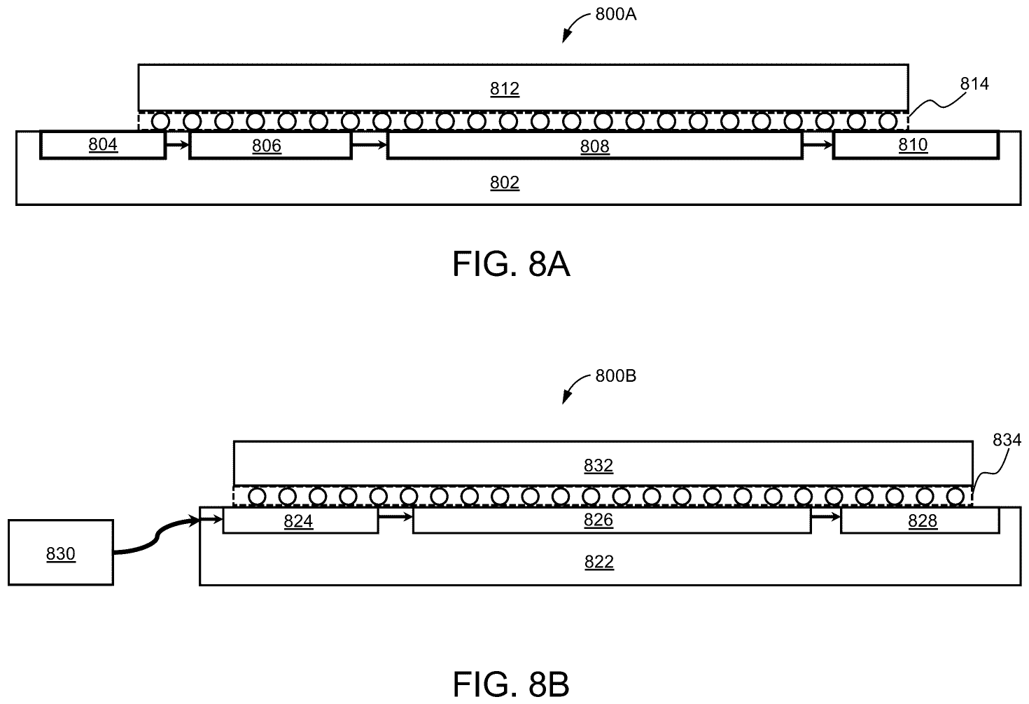

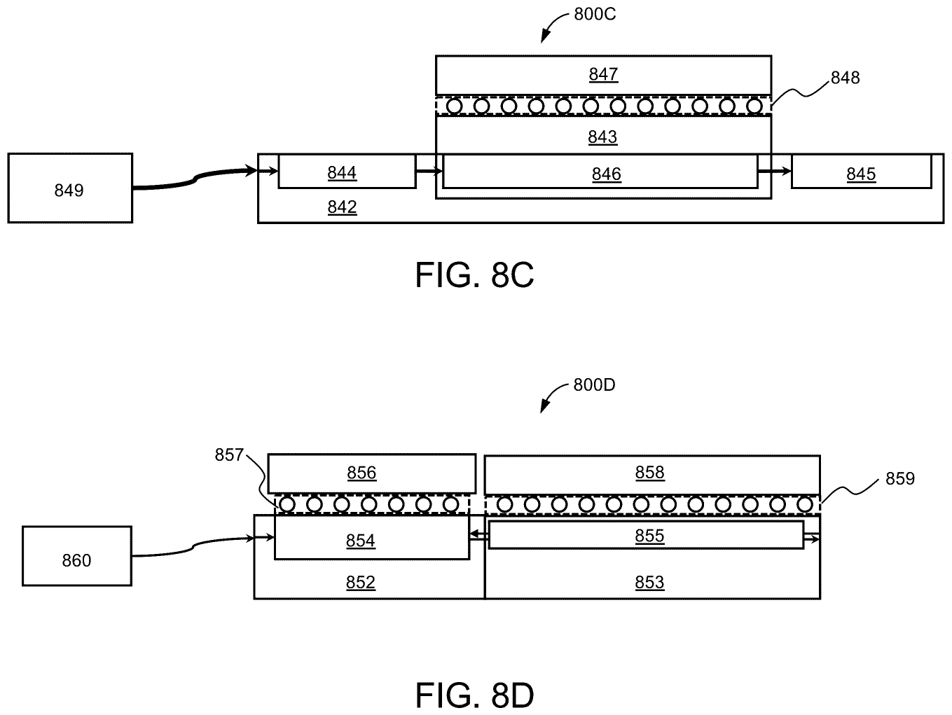

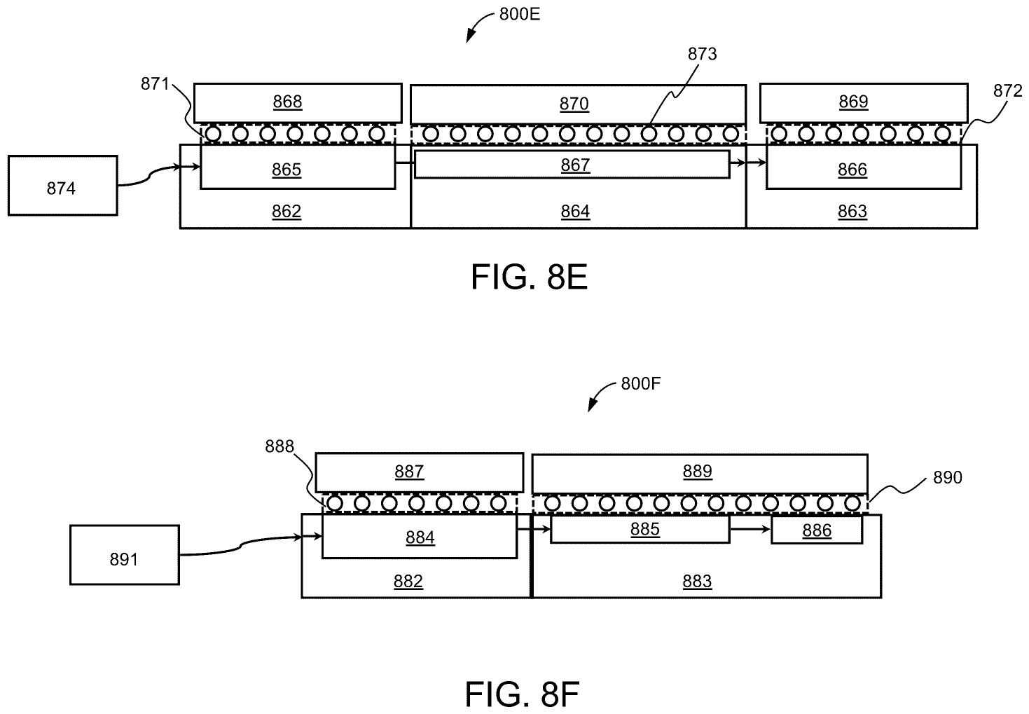

FIG. 8A depicts a side view of an example device 800A comprising a chip 802 of a first material. The chip 802 comprises an optical source 804, modulators 806, optical processor 808, and photodiodes 810. The device 800A comprises an electronic integrated circuit 812 that can be configured to control the optical source 804, modulators 806, optical processor 808, and photodiodes 810. The electronic integrated circuit 812 is connected to the components on the chip 802 by a plurality of conductive structures 814. In some implementation, the chip 802 can comprise a III/V material and the plurality of conductive structures 814 can comprise metal bumps such that the chip 802 and the electronic integrated circuit 812 are connected in a flip-chip configuration.

In some implementations, one or more photonic integrated circuits comprising a III/V material can co-packaged along with one or more silicon photonic integrated circuits that includes some fraction of the ADONN, such as photodetectors and modulators. In some implementations, an optical source can be separate from other components.

FIG. 8B depicts a side view of an example device 800B comprising a chip 822 of a first material. The chip 822 comprises modulators 824, optical processor 826, and photodiodes 828. The device 800B comprises an optical source 830 that is coupled into the chip 822. In some implementations, the first material can comprise silicon. An electronic integrated circuit 832 is connected to each structure of the chip 822 by a plurality of conductive structures 834.

FIG. 8C depicts a side view of an example device 800C comprising a first chip 842 of a first material and a second chip 843 of a second material. The first chip 842 comprises modulators 844 and photodiodes 845. The second chip 843 comprises an optical processor 846. The device 800C also comprises an electronic integrated circuit 847 that is connected to the second chip 843 by a plurality of conductive structures 848. An optical source 849 is coupled to the first chip 842. In some implementations, the first material can comprise silicon and the second material can comprise a III/V material.

FIG. 8D depicts a side view of an example device 800D comprising a first chip 852 of a first material and a second chip 853 of a second material. The first chip 852 comprises modulators 854. The second chip 853 comprises an optical processor 855. The device 800D also comprises a first electronic integrated circuit 856 that is connected to the modulators 854 of the first chip 852 by a plurality of conductive structures 857 and a second electronic integrated circuit 858 that is connected to the optical processor 855 of the second chip 853 by a plurality of conductive structures 859. An optical source 860 is coupled into the first chip 852. Detectors (not shown) can detect the light from the second chip 853. In some implementations, the first material can comprise silicon and the second material can comprise a III/V material.

FIG. 8E depicts a side view of an example device 800E comprising a first chip 862 and a second chip 863 of a first material and a third chip 864 of a second material. The first chip 862 comprises modulators 865, the second chip 863 comprises detectors 866, and the third chip 864 comprises an optical processor 867. The device 800E also comprises electronic integrated circuit 868, 869, 870. Each electronic integrated circuit 868, 869, 870 is connected to the respective first, second, and third chip 862, 863, 864 by a respective plurality of conductive structures 871, 872, 873. An optical source 874 is coupled to the first chip 862. In some implementations, the first material can comprise silicon and the second material can comprise a III/V material.

FIG. 8F depicts a side view of an example device 800F comprising a first chip 882 of a first material and a second chip 883 of a second material. The first chip 882 comprises modulators 884. The second chip 883 comprises an optical processor 885 and detectors 886. The device 800D also comprises a first electronic integrated circuit 887 that is connected to the first chip 882 by a plurality of conductive structures 888 and a second electronic integrated circuit 889 that is connected to the second chip 883 by a plurality of conductive structures 890. An optical source 891 is coupled to the first chip 882. In some implementations, the first material can comprise silicon and the second material can comprise a III/V material.

As shown in FIGS. 8A-8F, in some implementations, a III/V material can provide the optical gain and can include some of the other functions of the ADONN such as generating light, modulating light, or detecting light. In some implementations, a device can be entirely constructed in a silicon photonic process which includes gain in the process and uses the integrated gain for slab-mode propagation. In some implementations, an ADONN can be constructed entirely in a silicon photonic process and can be a PN junction configured as a slab-mode waveguide to attenuate the intensity and/or modulate the phase of light within the slab.

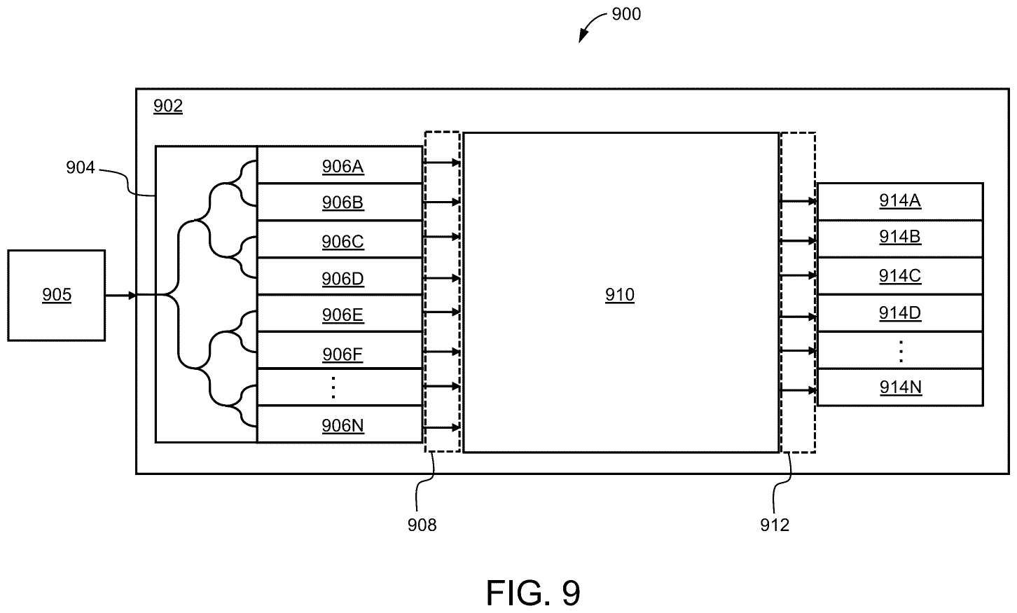

FIG. 9 depicts a top view of an example device 900 comprising a photonic integrated circuit 902. The photonic integrated circuit 902 comprises a splitting region 904 that is configured to receive light from an optical source 905 and split the light into N waveguides 906A-906N, where N is any number. In some implementations, each waveguide 906A-906N can comprise an intensity modulator. Each intensity modulator can be driven by an electronic circuit (not shown) which can convert a digital input signal into a voltage or current that changes the modulation strength. The output 908 of the modulators is directed to an optical processor 910 comprising an optical gain medium forming a slab-mode waveguide with gain. The output 912 of the optical processor 910 is directed to a plurality of waveguides 914A-914N. In some implementations, each waveguide 914A-914N can be coupled to a respective photodetector or photodiode. An electronic circuit (not shown) can amplify and digitize the photocurrent generated by each photodiode.

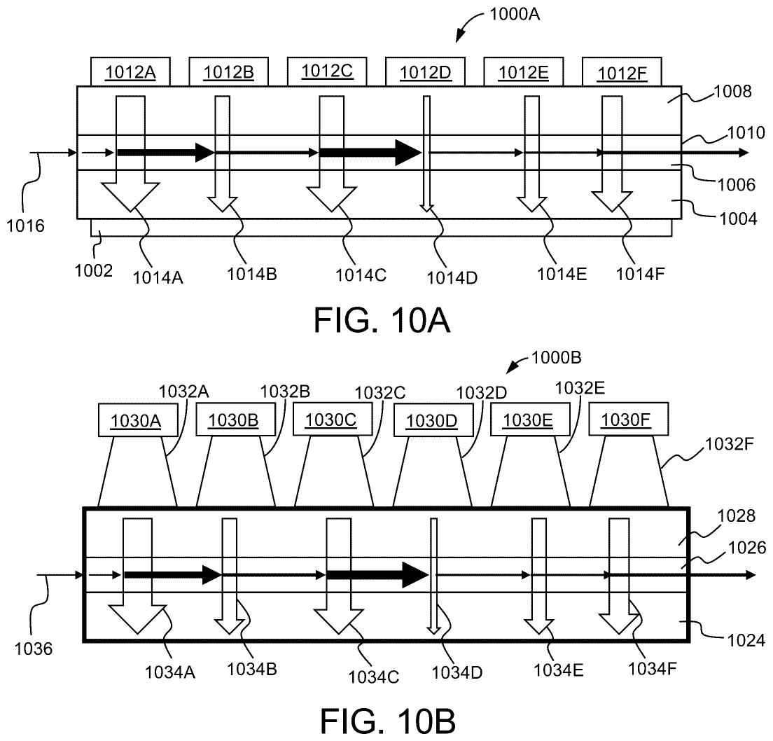

In some implementations, an array of N waveguides can be coupled into the junction formed at the interface of a p-doped and n-doped region in an optical gain medium, forming a slab-mode waveguide with gain. FIG. 10A depicts a side view of an example optical processor 1000A. The optical processor 1000A comprises a cathode layer 1002 comprising metal, a layer 1004 of a semiconductor material, an active region 1006 forming a layer, and a layer 1008 of a semiconductor material. In some implementations, the layer 1004 can be doped with n-type dopants and the layer 1008 can be doped with p-type dopants. The active region 1006 can be coupled to one or more waveguides at the optical interface 1010. A plurality of metal contacts 1012A-1012F each form a respective anode contact. In some implementations, the anode contacts can be spaced tightly together with a pitch close to the wavelength of light used in the system. An electronic circuit (not shown) can be connected to the metal contacts 1012A-1012F, allowing different currents 1014A-1014F to be driven by each metal contact 1012A-1012F. In some implementations, the currents 1014A-1014F can be different from each other, as represented by the size of the arrows. In some implementations, as the electronic circuit varies current into each metal contact 1012A-1012F, the absorption/gain of the slab mode waveguide can be locally varied around the metal contact 1012A-1012F due to the local current density variation. The intensity of light 1016 coupled into the active region 1006 can be varied as a result of the currents 1014A-1014F, as represented by the thickness of the solid black arrows.

In some implementations, an optical processor can be optically pumped. FIG. 10B depicts a side view of an example optical processor 1000B. The optical processor 1000B comprises a first layer 1024 of a material, an active region 1026, and a second layer 1028 of a material. In some implementations, the material can comprise glass and the active region 1026 can comprise doped glass or a laser crystal. A plurality of light sources 1030A-1030F emit respective light 1032A-1032F. An electronic circuit (not shown) can control the intensity of each light source 1030A-1030F. The light 1032A-1032F drives a respective current 1034A-1034F in the active region 1026. In some implementations, the currents 1034A-1034F can be different from each other, as represented by the size of the arrows. The intensity of light 1036 coupled into the active region 1026 can be varied as a result of the currents 1034A-1034F, as represented by the thickness of the solid black arrows. An array of detectors or photodiodes (not shown) at the output of the slab can convert light into photocurrent, and an electronic circuit (not shown) can amplify and digitize the light from each photodiode.

An architecture for a photonic neural network processor can allow on-the-fly reconfiguration of weights and non-linear activation functions in the propagation medium. A photonic neural network can use variably pumped optical gain to encode the weights of the hidden layers and can use the propagation of light to solve a neural network. In some implementations, a photonic neural network can have low latency and enable high computational density. Some photonic neural networks can be constructed out of silicon photonic integrated circuits, III/V photonic integrated circuits, heterogeneously integrated silicon and III/V integrated circuits or out of bulk optics that can be controlled and monitored by electronic and photonic integrated circuits.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
a plurality of optical processing stages configured to process two or more optical waves having a spectral peak wavelength, λ, wherein each of two or more of the plurality of optical processing stages comprises:
two or more configurable optical structures that are substantially coplanar with a plane, where each configurable optical structure is configured to receive an optical wave propagating along a first axis that is substantially parallel to the plane and each configurable optical structure comprises an active region having:
a width along a second axis that is substantially parallel with the plane and perpendicular to the first axis, where the width is less than or equal to 2λ,
a height along a third axis that is substantially perpendicular to the plane and perpendicular to the first axis, where the height is greater than λ/10, and
a length along the first axis that is less than or equal to 100λ; and
an interface region configured to receive optical waves from each configurable optical structure in the two or more configurable optical structures;
wherein each interface region associated with a respective optical processing stage of at least two of the plurality of optical processing stages is configured to couple at least a portion of an optical wave received from at least one configurable optical structure to at least two configurable optical structures in a subsequent optical processing stage.

2. The apparatus of claim 1, wherein each active region is configured to guide up to four spatial modes associated with an optical wave.

3. The apparatus of claim 1, wherein each active region is configured to contain a respective percentage of electromagnetic power associated with an optical wave propagating through the respective active region that is greater than 50% relative to a total electromagnetic power associated with the optical wave propagating through the configurable optical structure that comprises the respective active region.

4. The apparatus of claim 3, wherein each active region is configured to contain a percentage of electromagnetic power associated with an optical wave propagating through the respective active region that is greater than 70% relative to a total electromagnetic power associated with the optical wave propagating through the configurable optical structure that comprises the respective active region.

5. The apparatus of claim 1, wherein at least a portion of each active region of a respective optical processing stage is separated from at least a portion of one or more other active regions of the respective optical processing stage by a portion of a region comprising an insulating material.

6. The apparatus of claim 5, wherein each region comprising an insulating material extends along a respective axis that is substantially perpendicular to the plane and parallel to the third axis below a respective surface of each adjacent active region.

7. The apparatus of claim 1, wherein at least a portion of each active region of a respective optical processing stage is separated from at least a portion of one or more other active regions of the respective optical processing stage by a respective air-insulated gap.

8. The apparatus of claim 1, wherein each interface region comprises a slab-mode waveguiding structure formed within a substrate, where the slab-mode waveguiding structure is coupled to a plurality of configurable optical structures at a first end and the slab-mode waveguiding structure is coupled to a plurality of configurable optical structures at a second end opposite the first end.

9. The apparatus of claim 1, wherein each configurable optical structure in the two or more configurable optical structures is configured to provide an intensity change of an optical wave propagating through each respective active region with one or more of the intensity changes providing an optical gain to the optical wave.

10. The apparatus of claim 9, wherein the optical gain that each configurable optical structure is configured to provide to an optical wave is nonlinear in an intensity of the optical wave.

11. The apparatus of claim 1, wherein at least one configurable optical structure is able to be configured to transmit at least a portion of one or more optical waves in a first mode of operation and is able to be configured to detect an intensity of an optical wave in a second mode of operation.

12. The apparatus of claim 1, wherein each active region of the configurable optical structures comprises a first semiconductor material.

13. The apparatus of claim 1, wherein each configurable optical structure further comprises
a first layer comprising a first semiconductor material,
a second layer comprising the active region, where the active region comprises a second semiconductor material, and
a third layer comprising a third semiconductor material,
wherein the second layer is between the first layer and the third layer.

14. The apparatus of claim 13, wherein the second layer further comprises
a fourth layer comprising a fourth semiconductor material, where the fourth layer is between the first layer and the active region, and
a fifth layer comprising the fourth semiconductor material, where the fifth layer is between the third layer and the active region.

15. The apparatus of claim 14, wherein the fourth semiconductor material comprises a composition of indium gallium arsenide phosphide.

16. The apparatus of claim 13, wherein a portion of the active region comprises a quantum well.

17. The apparatus of claim 13, wherein a portion of the active region comprises a bulk semiconductor material.

18. The apparatus of claim 13, wherein the first layer comprises the first semiconductor material with dopants mixed within and the third layer comprises the third semiconductor material with dopants mixed within.

19. The apparatus of claim 18, wherein either (1) the dopants of the first layer comprise p-type dopants and the dopants of the third layer comprise n-type dopants or (2) the dopants of the first layer comprise n-type dopants and the dopants of the third layer comprise p-type dopants.

20. The apparatus of claim 13, wherein the first semiconductor material and the third semiconductor material each comprise a composition of indium gallium arsenide phosphide.

21. The apparatus of claim 13, wherein the second semiconductor material comprises a composition of indium gallium arsenide phosphide.

22. The apparatus of claim 1, wherein a respective optical wave is provided to each configurable optical structure of an optical processing stage of the plurality of optical processing stages.

23. The apparatus of claim 22, wherein the respective optical wave is provided to each configurable optical structure by a respective modulator.

24. The apparatus of claim 1, wherein at least a first active region is configured to control an optical property associated with an optical wave propagating through the first active region.

25. The apparatus of claim 24, wherein the optical property that the first active region is configured to control is an optical power associated with an optical wave propagating through the first active region.

26. The apparatus of claim 25, wherein the first active region is configured to increase an optical power associated with an optical wave propagating through the first active region.

27. The apparatus of claim 24, wherein the first active region comprises a semiconductor material having a bandgap energy that is lower than an energy associated with the spectral peak wavelength, λ, of the two or more optical waves.

28. The apparatus of claim 27, wherein the semiconductor material is a direct bandgap semiconductor material.

29. The apparatus of claim 24, wherein the first active region is configured to control an optical property associated with an optical wave propagating through the first active region based at least in part on an electro-optic effect or a thermo-optic effect.

30. The apparatus of claim 1, wherein each active region comprises a material that is configured to control an optical property associated with an optical wave traveling through the respective active region based at least in part on a nonlinear susceptibility associated with the material.

31. The apparatus of claim 30, wherein each active region is configured to control an optical property associated with an optical wave by one or more of the following electro-optic effects: (1) a Franz-Keldysh effect, (2) a quantum-confined Stark effect, (3) a Pockels effect, (4) a plasma dispersion effect or (5) a Kerr effect.

32. The apparatus of claim 1, wherein each interface region consists essentially of a passive material.

33. An apparatus comprising:
an integrated circuit device comprising
a first layer comprising a metal,
a second layer comprising a first semiconductor material,
a third layer comprising an active region of a second semiconductor material, and
a fourth layer comprising a third semiconductor material,
wherein the second layer is between the first layer and the third layer, and the third layer is between the second layer and the fourth layer;
an optical interface configured to provide two or more optical waves into different respective portions of the active region along different respective propagation axes that are substantially parallel to each other including at least a first propagation axis and a second propagation axis;
a plurality of metal contacts in electrical communication with the fourth layer, wherein a first subset of the metal contacts is arranged along the first propagation axis, and a second subset of the metal contacts is arranged along the second propagation axis; and
an electrical source configured to apply a respective electric field between the first layer and each metal contact of the plurality of metal contacts.

34. The apparatus of claim 33, wherein the first layer is in electrical communication with the second layer.

35. The apparatus of claim 33, wherein the second layer further comprises dopants mixed within the first semiconductor material and the fourth layer further comprises dopants mixed within the third semiconductor material.

36. The apparatus of claim 35, wherein either (1) the dopants of the second layer comprise n-type dopants and the dopants of the fourth layer comprise p-type dopants or (2) the dopants of the second layer comprise p-type dopants and the dopants of the fourth layer comprise n-type dopants.

37. The apparatus of claim 33, wherein the first semiconductor material and the third semiconductor material comprise indium phosphide.

38. The apparatus of claim 33, wherein the second semiconductor material comprises a composition of indium gallium arsenide phosphide.

39. The apparatus of claim 33, wherein the fourth layer further comprises a plurality of regions of the third semiconductor material having dopants mixed within, where each metal contact of the plurality of metal contacts is in electrical communication with at least a portion of a different respective region of the plurality of regions.

40. The apparatus of claim 39, wherein at least a portion of each region of the plurality of regions is separated from at least a portion of each other region of the plurality of regions by a portion of the third semiconductor material without dopants or by a region devoid of the third semiconductor material.

41. The apparatus of claim 40, wherein one or more of the regions devoid of the third material comprise an electrically insulating or optically transparent material.

42. The apparatus of claim 33, wherein each portion of the active region between a metal contact of the plurality of metal contacts and first layer is configured to provide an intensity change of an optical wave propagating through the respective portion of the active region based at least in part on the respective electric field applied between the first layer and the metal contact of the plurality of metal contacts, with one or more of the intensity changes providing an optical gain to the optical wave.

43. The apparatus of claim 42, wherein the optical gain that each portion of the active region is configured to provide to an optical wave is nonlinear in an intensity of the optical wave.

44. The apparatus of claim 33, wherein the third layer further comprises
a fifth layer comprising a fourth semiconductor material, where the fifth layer is between the second layer and the active region, and
a sixth layer comprising the fourth semiconductor material, where the sixth layer is between the fourth layer and the active region.

45. The apparatus of claim 44, wherein the fourth semiconductor material comprises a composition of indium gallium arsenide phosphide.

46. The apparatus of claim 33, wherein a portion of the active region comprises a quantum well.

47. The apparatus of claim 33, wherein a portion of the active region comprises a bulk semiconductor material.

48. An apparatus comprising:
a configurable optical structure configured to receive an input optical wave propagating along a first axis, wherein the input optical wave has a spatial profile that is distributed along a second axis that is perpendicular to the first axis and a third axis that is perpendicular to the first axis and the second axis,
a first optical pump beam interface configured to provide a first set of two or more optical pump beams, wherein each optical pump beam of the first set of two or more optical pump beams is directed into the configurable optical structure along a respective axis that is perpendicular to the first axis and parallel to the second axis, and
a second optical pump beam interface configured to provide a second set of two or more optical pump beams, wherein each optical pump beam of the second set of two or more optical pump beams is directed into the configurable optical structure along a respective axis that is perpendicular to the first axis and parallel to the third axis.

49. The apparatus of claim 48, wherein the configurable optical structure comprises a region that is at an intersection between an optical pump beam from the first set of two or more optical pump beams and an optical pump beam from the second set of two or more optical pump beams.

50. The apparatus of claim 49, wherein the configurable optical structure is configured to control an intensity of an optical wave propagating through the region by providing optical gain to an input optical wave propagating through the region.

51. The apparatus of claim 50, wherein the optical gain that the region is configured to provide to an optical wave is nonlinear in an intensity of the optical wave.

52. The apparatus of claim 48, wherein the configurable optical structure comprises a plurality of regions, where each region of the plurality of regions is at an intersection between an optical pump beam from the first set of two or more optical pump beams and an optical pump beam form the second set of two or more optical pump beams.

53. The apparatus of claim 48, wherein the configurable optical structure comprises a laser crystal or glass doped with rare-earth elements.

54. The apparatus of claim 48, wherein the input optical wave is a collimated light source.

55. The apparatus of claim 48, wherein each optical pump beam in the first set of two or more optical pump beams comprises an optical wave having a first wavelength and each optical pump beam in the second set of two or more optical pump beams comprises an optical wave having a second wavelength, where the first wavelength and the second wavelength are determined based at least in part a material of the configurable optical structure.
